(19) United States
(12) Patent Application Publication
(10) Pub. No.: US 2026/0073468 A1
(43) Pub. Date: Mar. 12, 2026

(54) LARGE GRAPH PARTITIONING METHOD USING STREAMING CLUSTERING IN GPU ENVIRONMENT

(71) Applicant: CHUNGBUK NATIONAL UNIVERSITY INDUSTRY-ACADEMIC COOPERATION FOUNDATION, Cheongju-si (KR)

(72) Inventors: Hyeonbyeong LEE, Cheongju-si (KR); Sangho SONG, Cheongju-si (KR); Jongtae LIM, Cheongju-si (KR); Jaesoo YOO, Cheongju-si (KR)

(73) Assignee: CHUNGBUK NATIONAL UNIVERSITY INDUSTRY-ACADEMIC COOPERATION FOUNDATION, Cheongju-si (KR)

(21) Appl. No.: 19/063,056

(22) Filed: Apr. 30, 2025

(30) Foreign Application Priority Data
Sep. 6, 2024 (KR) 10-2024-0121574

(51) Int. Cl. G06T 1/20

(52) U.S. Cl. CPC G06T 1/20

(57) ABSTRACT

Provided is a large graph partitioning method using streaming clustering in a GPU environment. A CPU gradually compresses graph data by considering a structural environment of a GPU and then transfers the compressed graph data to a GPU memory to perform graph partitioning, thereby utilizing the memory of the GPU most efficiently and performing fast graph processing. As a result, the large graph partitioning method using streaming clustering in a GPU environment relates to a technology that can effectively process connection information for all clusters in parallel by utilizing the high computational amount of the GPU and overcome the memory limitations of the GPU by processing computations that require a large memory space in the CPU.

### CROSS-REFERENCE TO RELATED APPLICATIONS

This application claims the benefit of priority under 35 U.S.C. § 119 to Korean Patent Application No. 10-2024-0121574, filed Sep. 6, 2024, the contents of which are incorporated herein by reference in its entirety.

### TECHNICAL FIELD

The following disclosure relates to a large graph partitioning method using streaming clustering in a GPU environment, and more particularly, to a large graph partitioning method using streaming clustering in a GPU environment, capable of improving data processing efficiency by compressing a graph through clustering so that large graph partitioning may be performed within limited memory resources of a GPU.

### BACKGROUND

Graphs are used as a core data structure in various fields. A structure of a graph may express entities (for example, people or objects) and relationships between entities and is used in medical information systems and social network analysis. Recently, due to the development of network technology and the spread of social network services, such as Twitter and Facebook, the scale of data has increased exponentially.

As a result, a ‘large graph’ that is much larger than existing graphs is required, and a large graph is a graph with a very large number of vertices and edges and is used for more effective analysis and many applications than existing graphs. In order to analyze such large graphs, more computing resources are required.

In the related art, a single computer, or a single system, using a CPU was sufficient to process all data, but in the case of large graphs, it is impossible for a single system to process large graphs.

To solve this problem, a method of distributing large graph data to multiple systems or nodes and storing and processing them has been proposed. The efficiency of the graph partitioning technology is considered an important factor in processing large graph data.

Graph partitioning techniques in CPU environments are largely classified into two types. One is an in-memory graph partitioning technique, which loads the entire graph into memory and performs batch processing, and the other is a streaming graph partitioning technique, which gradually loads a graph into memory and repeats processing. Recently, with the development of graphic processing units (GPUs), distributed parallel processing techniques using GPUs have become important. GPUs are devices that process graphics, but they are also used to process large amounts of data. Single instruction multiple threads (SIMT) computing of GPUs has been used to utilize data parallelism and accelerate calculations. GPUs have the characteristic of providing very high throughput and may execute a large number of threads simultaneously, which are effective for performing data parallel processing.

Nevertheless, there are clear limitations to loading large graph data on GPUs. In general, GPUs have relatively small memory capacity compared to CPUs, so it is impossible to load large graph data into GPU memory. For example, the existing technique Thanos proposed a fast graph partitioning algorithm using a cross-partitioning algorithm, but when the data is very large, there is a problem that it is difficult to perform graph partitioning due to GPU out of memory.

In this regard, Japanese Patent Publication No. 6346893 (“Hybrid GPU/CPU Data Processing Method”) discloses a technology for executing a large graph search on a parallel processing platform.

### RELATED ART DOCUMENT

### Patent Document

Japanese Patent No. 6346893 (registration date: Jun. 1, 2018.)

### SUMMARY

An exemplary embodiment of the present invention is directed to providing a streaming clustering-based graph partitioning technique capable of efficiently processing a large graph by complementing the memory limitations of GPUs.

In one general aspect, a large graph partitioning method using streaming clustering in a GPU environment includes an input operation (S100) of receiving, by a CPU, which is a host, original graph data; a clustering operation (S200) of generating, by the CPU, a cluster map array for the received original graph data using a streaming clustering algorithm and generating cluster graph data using the cluster map array generated for the original graph data; a transmission operation (S300) of receiving, by a GPU, the generated cluster graph data; an initial partitioning operation (S400) of performing, by the GPU, initial partitioning on the received cluster graph data by applying a pre-stored algorithm; and an optimization operation (S500) of receiving, by the CPU, assigned partition label data, which is an initial partitioning result, and performing optimization on the assigned partition label data using the generated cluster map array.

In the clustering operation (S200), the original graph data may be assumed to have a form of an edge stream (ES) in which edges are sequentially input, edge information may be provided in batch units, and vertices that are closely connected to each vertex may be grouped into the same cluster.

In the initial partitioning operation (S400), a label of each node may be repeatedly updated according to a label distribution of neighbor nodes by applying a label propagation algorithm, which is a pre-stored algorithm.

In the optimization operation (S500), it may be determined, for each vertex, whether quality of a partitioned graph is improved when each vertex is assigned to a different partition of a neighboring vertex, rather than an assigned partition, and optimization of graph partitioning may be performed through vertex replication according to a determination result.

Other features and aspects will be apparent from the following detailed description, the drawings, and the claims.

### BRIEF DESCRIPTION OF THE DRAWINGS

FIG. 1 is an exemplary diagram illustrating a related art graph partitioning method.

FIG. 2 is an exemplary diagram illustrating a flowchart of a large graph partitioning method using streaming clustering in a GPU environment according to an exemplary embodiment of the present invention.

FIG. 3 is an exemplary diagram illustrating a structure of the large graph partitioning method using streaming clustering in a GPU environment according to an exemplary embodiment of the present invention.

FIG. 4 is an exemplary diagram illustrating a cluster graph generating process through a clustering operation (S200) in the large graph partitioning method using streaming clustering in a GPU environment according to an exemplary embodiment of the present invention.

FIG. 5 is an exemplary diagram illustrating a data conversion process through an initial partitioning operation (S400) in the large graph partitioning method using streaming clustering in a GPU environment according to an exemplary embodiment of the present invention.

FIG. 6 is an exemplary diagram illustrating a partition assigning process through an initial partitioning operation (S400) in the large graph partitioning method using streaming clustering in a GPU environment according to an exemplary embodiment of the present invention.

FIG. 7 is an exemplary diagram illustrating a vertex replication process through an optimization operation (S500) in the large graph partitioning method using streaming clustering in a GPU environment according to an exemplary embodiment of the present invention.

### DETAILED DESCRIPTION OF EXEMPLARY EMBODIMENTS

Hereinafter, a large graph partitioning method using streaming clustering in a GPU environment according to the present invention will be described in detail with reference to the accompanying drawings. The exemplary embodiments of the present invention to be introduced below are provided by way of example so that the idea of the present invention may be sufficiently transferred to those skilled in the art to which the present invention pertains. Accordingly, the scope of the present invention is not restricted to the following description and accompanying drawings and may be embodied in another form. In addition, throughout the specification, like reference numerals denote like components.

Here, unless indicated otherwise, the terms used in the specification including technical and scientific terms have the same meaning as those that are usually understood by those who are skilled in the art to which the present invention pertains, and detailed description of the known functions and constitutions that may obscure the gist of the present invention will be omitted.

In addition, the system means a set of components including apparatuses, mechanisms, units, etc. which are organized and regularly interact with each other to perform required functions.

A large graph partitioning method using streaming clustering in a GPU environment according to an exemplary embodiment of the present invention is intended to propose a technique capable of overcoming memory limitations of a GPU and efficiently processing large graph data. Considering a structural environment of the GPU, a CPU may gradually compress graph data and then transfer the compressed graph data to a GPU memory to perform graph partitioning, thereby utilizing the GPU memory most efficiently and performing fast graph processing. As a result, connection information for all clusters may be effectively processed in parallel using the high computational amount of the GPU, and computations requiring a large amount of memory space are processed in the CPU, thereby overcoming the memory limitations of the GPU.

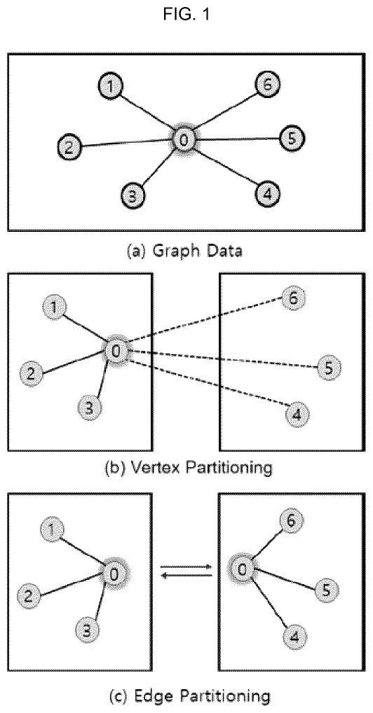

The graph partitioning methods of the related art are largely divided into vertex-centered and edge-centered. As described with reference to FIG. 1, when graph data, such as a) of FIG. 1 is input, vertex-centered partitioning is as b) of FIG. 1, and edge-centered partitioning is as c) of FIG. 1. In the case of vertex-centered partitioning, since the neighbor information of a vertex is mainly utilized, partitioning may be performed by analyzing the role or importance of the vertex, and is utilized for the advantage of community identification or partial graph identification including important vertices. In the case of edge-centered partitioning, partitioning is performed by focusing on the distribution and connectivity of edges. This is mainly advantageous when minimizing the communication cost of the graph.

While vertex-centered partitioning has to store all the location information of the vertex for each cut edge, edge-centered partitioning may save storage space by storing less of the corresponding information. In edge-centered partitioning, some vertices are stored in duplicate in other portions (partitions), but this contributes to reducing the overall amount of data. Edge-centered partitioning is particularly efficient in graphs that follow a power-law distribution, and in this case, when there is a significant difference in the number of neighbors of a vertex, the partitioning may be better balanced.

Minimizing the number of replicated vertices is a key factor in increasing the efficiency of edge-centered partitioning, and such optimization is even more important in a distributed environment.

As fewer vertices are assigned to each partition and as replicated vertices are fewer, the communication cost may be reduced and the efficiency of the entire system is improved.

As described above, graph partitioning in the GPU environment is an important consideration from the perspective of data processing. In order to process a graph, all data including vertex and edge information are transferred to the GPU memory and processed. In this process, efficient use of GPU memory and minimization of memory usage are essential to perform effective graph partitioning.

Generally, graph data is moved from the CPU memory to the GPU memory for algorithm execution, and after graph partitioning is completed, the result is assigned to the GPU memory. The partitioned graph is then moved back to the CPU memory. Most graph partitioning algorithms that utilize the data parallelism of GPUs adopt an in-memory approach. The memory limitations of graph partitioning in the GPU environment mainly appear in two aspects. First, GPU memory capacity is limited compared to the CPU memory and is generally less than 20% of the CPU memory size. The GPU memory is limited to several GB to tens of GB, which may be insufficient to store the entire graph data on a large scale. Second, a data transfer rate between the CPU and the GPU may be relatively slow, and overhead occurs during data transfer due to the use of separate memory space. To reduce the overhead, data replication should be minimized and a memory copy process should be optimized.

An example of a graph partitioning method optimized for the GPU environment is to adopt a multi-level approach to efficiently partition large graph data and to accelerate the graph partitioning task by utilizing the parallel processing capability of the GPU. Graph partitioning is performed in three stages of reduction, initial partitioning, and expansion. When an input graph is given, in the reduction stage, vertex pairs are grouped centered on edges with large weights in the reduction stage and a load is distributed by dynamically assigning SIMT threads of the GPU. In the initial partitioning stage, the graph is partitioned through parallel BFS, and in this process, the partition weights and cut edges are estimated based on the grouped vertices. Finally, in the expansion stage, the reduced vertices are expanded by utilizing the information obtained from the initial partitioning, and the edge cuts are minimized by repeatedly moving boundary vertices.

Based on the related arts, a large graph partitioning method using streaming clustering in the GPU environment according to an exemplary embodiment of the present invention has the primary technical goal of performing graph partitioning within a limited memory resource of the GPU. GPU-based graph partitioning techniques generally compress graph data in the form of CSR compressed sparse row (CSR) or coordinate list (COO). The memory compression technique is advantageous in loading graph data by minimizing memory usage in the GPU. However, loading large graph data into the GPU memory is still a difficult task. Even if the graph is compressed in the form of COO or CSR, memory as much as |E| corresponding to the total number of edges is required, and an adjacency matrix requires space as much as the square of the number of vertices. For example, the NVIDIA GeForce RTX 3060 (12 GB) cannot batch-process data with about 300 million or more edges.

In order to solve these problems, a large graph partitioning method using streaming clustering in a GPU environment according to an exemplary embodiment of the present invention aims to maximize the computational capability of the GPU and data processing efficiency by compressing large graph data through clustering.

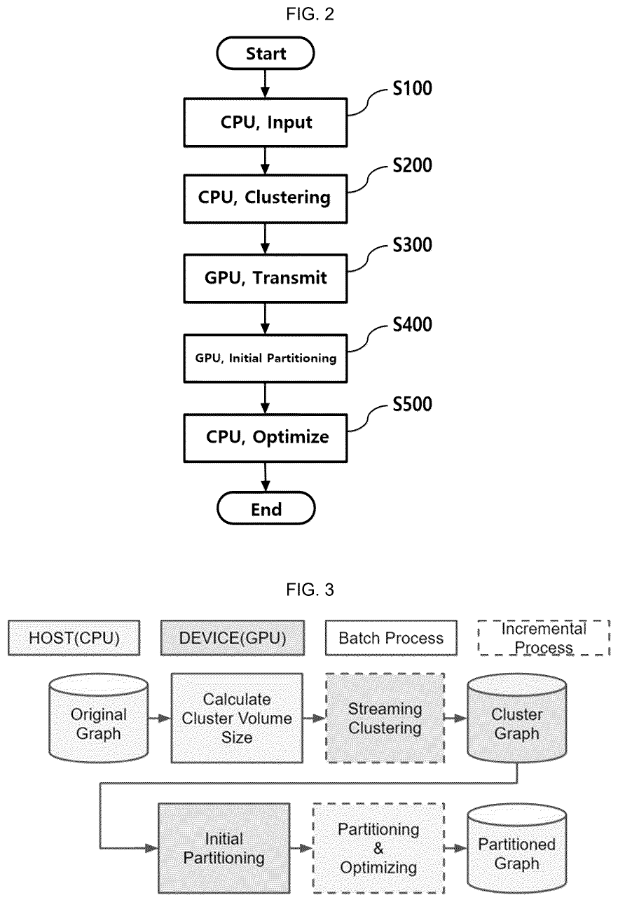

The large graph partitioning method using streaming clustering in a GPU environment according to an exemplary embodiment of the present invention includes an input operation (S100), a clustering operation (S200), a transmission operation (S300), an initial partitioning operation (S400), and an optimization operation (S500), as shown in FIG. 2. Naturally, each step is performed by a CPU or a computational processing means including a GPU.

FIG. 3 is an exemplary diagram illustrating a structure of the large graph partitioning method using streaming clustering in a GPU environment according to an exemplary embodiment of the present invention. Briefly, the CPU receives input graph data. The graph includes many edges, and the CPU gradually reads the edges of the graph one by one and group edges with similar characteristics to generate cluster data. In other words, the input data is processed as an edge stream (ES), and cluster information is generated through streaming clustering. The generated cluster information is managed as an array called a cluster map in the CPU, which indicates a cluster affiliation of each vertex. In other words, it indicates which cluster each vertex belongs to. Thereafter, the input graph is converted into a cluster graph using the cluster map. Before transmission to the GPU, a data size is compressed to match a cluster size and the GPU memory. In other words, vertices belonging to the same cluster are regenerated as cluster units in the original graph according to a set maximum size setting value. This reduces the size of the data. The GPU performs an initial graph partitioning operation based on the transmitted cluster information and determines which part each cluster belongs to. A partition label, which is a result of this operation, is returned to the CPU. In the optimization process in the CPU, optimization considering a replication factor and load balancing is performed when replicating vertices by utilizing the ES again.

Through this, the CPU effectively transmits the cluster information to the GPU through streaming clustering, which minimizes data transmission between the CPU and the GPU and improves overall performance. The cluster graph may reflect the overall information of the data, so that high-quality graph partitioning may be performed in the GPU.

Based on this, referring to each operation, in the input operation (S100), the CPU, which is a host, receives original graph data.

In the clustering operation (S200), the CPU divides the entire data of the input original graph data into small clusters and compresses the same using the streaming clustering algorithm.

That is, the cluster map array for the input original graph data is generated, and cluster graph data is generated using the cluster map array generated from the original graph data.

In detail, in the clustering operation (S200), preferably, the original graph data is assumed to have a form of an edge stream (ES) in which edges are sequentially input, edge information is provided in batch units, and vertices that are closely connected to each vertex are grouped into the same cluster.

The core of the clustering operation (S200) is to group closely connected vertices within the graph data into the same cluster. That is, by grouping closely connected vertices in the graph data into the same cluster, the size of the entire graph data may be reduced, while maintaining the relevance between the vertices in each cluster. As a result, by identifying the concentrated connectivity of vertices in the graph data through the clustering process and reflecting the identified connectivity in the partitioning process, more efficient graph partitioning may be performed.

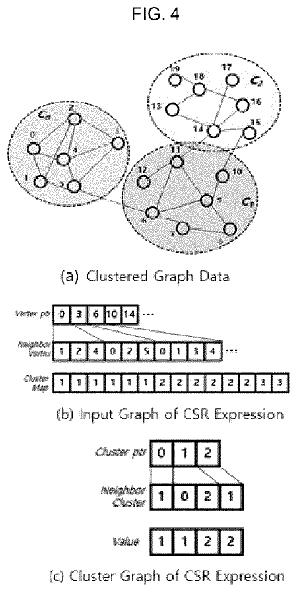

In detail, in the CPU, the input data is assumed to be in the form of the ES in which edges are sequentially input. The ES provides edge information in batch units, such as {(v1, v2), (v2, v3), . . . } and indicates to which vertex each vertex is connected. FIG. 4 is a diagram illustrating an example of a cluster graph for compressing the input graph data. (a) of FIG. 4 illustrates the input graph data, in which a small circle indicates a vertex and a large circle indicates a cluster. (b) of FIG. 4 is an example of converting the input graph data into a CSR representation. Here, a vertex pointer (Vertex ptr) indicates a starting point of a neighbor array (neighbor) of each vertex. For example, the neighbors of vertex 0 are vertices 1, 2, and 4. (b) of FIG. 4 illustrates compressed cluster data.

The clustering operation (S200) is designed by extending the existing research on streaming cluster algorithms. Table 1 below is an algorithm illustrating the clustering process.

TABLE 1
Algorithm 1. Streaming clustering

Input: edge_stream,max_vol,device
Output: unique_edges,edge_weight

| | |
|---|---|
| 1 | Initialize d,vol,v2c with zeros |
| 2 | cluster_weights,edge_index_list ← empty lists |
| 3 | |
| 4 | Function process_edges(edge_batch): |
| 5 | vs,vl ← find_smaller_volume_vertices(edge_batch) |
| 6 | c_vs,c_vl ← v2c[vs],v2c[vl] |
| 7 | mask ← (vol[c_vl] + d[vs] ≤ max_vol) AND (c_vs ≠ c_vl) |
| 8 | vol[c_vl[mask]] ← vol[c_vl[mask]] + d[vs[mask]] |
| 9 | vol[c_vs[mask]] ← vol[c_vs[mask]] − d[vs[mask]] |
| 10 | v2c[vs[mask]] ← c_vl[mask] |
| 11 | |
| 12 | for each edge_batch in edge_stream do |
| 13 | edge_batch ← move_to_device(edge_batch) |
| 14 | update_degrees(edge_batch) |
| 15 | process_edges(edge_batch) |
| 16 | |
| 17 | c0,c1 ← v2c[edge_batch] |
| 18 | cluster_edges ← get_cluster_edges(c0,c1) |
| 19 | Append cluster_edges to edge_index_list |
| 20 | |
| 21 | update_cluster_weights(c0,c1) |
| 22 | end for |
| 23 | |
| 24 | edge_index ← concatenate(edge_index_list) |
| 25 | unique_edges,edge_weight ← get_weighted_edges(edge_index) |
| 26 | |
| 27 | return unique_edges,edge_weight |

As described in Table 1 above, in the clustering operation (S200), edge_stream, a list including a batch of edges, and max_vol, an integer representing the maximum allowable volume of a cluster, are used as an input. As output, unique_edges, two-dimensional data representing edges between clusters, and edge_weight, a one-dimensional array representing the weight of edges between each cluster are generated.

The main variables include an array d that stores the degree of each vertex, an array vol that stores the volume of each cluster, an array v2c that stores the ID of the cluster to which each vertex belongs, an array cluster_weights that represents the number of vertices belonging to each cluster as weights, and a list edge_index_list that stores edge information between clusters.

The main functions of the algorithm include a process_edges function that processes a given edge batch to merge and update clusters and a find_smaller_volume_vertices function that determines which vertex belongs to the cluster with the smaller volume among the two endpoints of each edge.

Based on this, the algorithm processing process by the clustering operation (S200) is described. First, the d, vol, and v2c arrays are initialized to 0, and cluster weights and edge_index_list are initialized to empty lists. For each batch of edge_stream, the edge batch is moved to the GPU, the degree of the vertices is updated, and the process_edges function is called to merge and update the clusters. Thereafter, the edge information between clusters is extracted and added to the edge_index_list, and the cluster weights are updated.

After all edge batches are processed, the edge information between clusters stored in the edge_index_list is merged into one array, duplicate edges are removed, and the weights of each edge are calculated to generate unique_edges and edge_weight.

This algorithm may efficiently cluster large graphs through GPU acceleration and batch processing, and has the advantage of solving the memory shortage problem by optimizing memory usage. In addition, a balanced cluster is generated by applying a cluster volume constraint (max_vol).

The size of the compressed information considers the maximum size (Max_vol) of the cluster and a compression ratio (CR) considering the available memory space (global memory (GM)) of the GPU. This may be calculated using Equation 1 below.

In Equation 1, the compression ratio is obtained by dividing the available memory of the GPU by the size of the graph. In addition, in Equation 1, the maximum volume of the cluster (Max_vol) is calculated by multiplying the number of edges of the graph data by the compression ratio.

$$\begin{matrix}CR ( \% ) = \frac{GM}{Size of Graph} \times 100 \\ Max vol = \vert E \vert \times CR\end{matrix} \qquad [ Equation 1 ]$$

Through Equation 1, data may be reduced to the maximum processable size on the GPU and communication costs between the CPU and the GPU may be minimized. It may also operate efficiently for large graphs coming as the ES and may be utilized as a solution to dynamic clustering problems.

In the clustering operation (S200), when all edges are input and all vertices are assigned to clusters, information on connected edges between each cluster is identified.

In other words, in the clustering operation (S200), vertices that match clusters are compressed to form compressed graph data. That is, when a vertex belonging to C(i) and a vertex belonging to Cⱼ are connected to each other (when there are neighboring vertices within the cluster), edges are identified.

In the transmission operation (S300), the GPU receives the cluster graph data generated through the clustering operation (S200).

In the initial partitioning operation (S400), the GPU repeatedly updates the label of each node according to a label distribution of neighbor nodes by applying a label propagation algorithm, which is a pre-stored algorithm, and generates an initial partition, that is, an initially assigned partition label data, by intuitively reflecting the structure of the graph data.

In other words, in the initial partitioning operation (S400), local information of the original graph data is effectively utilized by applying the label propagation algorithm, and the labels of the nodes are repeatedly updated according to the label distribution of neighbor nodes. In addition, by reducing the size of the graph by utilizing the cluster graph, the GPU memory usage may be optimized and the parallel processing efficiency may be improved.

The initial partitioning operation (S400) is a key process that performs first partitioning for the cluster graph, as described in Table 2 below. The initial partitioning operation (S400) utilizes the label propagation algorithm, which has a simple structure and is very suitable for parallel execution on the GPU.

TABLE 2
Algorithm 2. Initial partitioning

Input: edge_index,edge_weight,num,clusters,max_iterations,batch_size
Output: labels

| 1 | num_nodes ← max(edge_index) + 1 | |
|---|---|---|
| 2 | labels ← [0,1,...,num_nodes − 1] | |
| 3 | adj ← CreateSparseAdjacencyMatrix(edge_index,edge_weight,num_nodes) | |
| 4 | | |
| 5 | for iteration = 1 to max_iterations do | |
| 6 | old_labels ← labels | |
| 7 | new_labels ← [0] • num_nodes | |
| 8 | for i = 0 to num_nodes step batch_size do | |
| 9 | batch_end ← min(i + batch_size,num_nodes) | |
| 10 | batch_prop ← MatrixMultiply(adj[i:batch_end],labels) | |
| 11 | new_labels[i:batch_end] ← ArgMax(batch_prop) | |
| 12 | end for | |
| 13 | labels ← new labels | |
| 14 | if labels = old_labels then | |
| 15 | break | |
| 16 | end if | |
| 17 | end for | |
| 18 | | |
| 19 | unique_labels,labels ← FindUniqueLabels(labels) | |
| 20 | if \|unique_labels\| > num_clusters then | |
| 21 | label_counts ← CountLabelOccurrences(labels) | |
| 22 | sorted_indices ← SortAscending(label_counts) | |
| 23 | label_map ← [0,1,...,\|unique_labels\| − 1] | |
| 24 | label_map[sorted_indices[:−num_clusters]] | |
| ... | | ← RandomSample(label_map,num_clusters) |

| | |
|---|---|
| 25 | labels ← UpdateLabels(labels,label_map) |
| 26 | end if |
| 27 | |
| 28 | return labels |

As described in Table 2 above, the edge_index and edge_weight of the cluster graph, the number of desired clusters (num_clusters), the maximum number of iterations (max_iterations), and the batch size (batch_size) are used as inputs. The cluster labels assigned to each node are returned as outputs.

A main processing process of the algorithm through the initial partitioning operation (S400) is as follows.

In the initialization operation (lines 1-3 of Table 2), the number of nodes is calculated and a unique label is assigned to each node. In addition, a sparse adjacency matrix is generated.

In a label propagation operation (lines 5-17 of Table 2), the process is repeated by the maximum number of iterations, and nodes are divided into batches and processed in each iteration. A matrix product of an adjacency matrix and a current label for each batch is calculated, and an index of the largest value in the calculated result is assigned as a new label.

In a post-processing process (lines 19-26 of Table 2), the number of generated unique labels is checked, and if necessary, the labels are adjusted to match the desired number of clusters.

Finally, in a result return process (line 28), the cluster labels of each node that have been finally determined are returned.

In this manner, the algorithm shown in Table 2 is designed to be executed efficiently in the GPU, and memory usage is optimized for large graphs through batch processing. In addition, in the label propagation process, an effective initial partition is generated by considering structural characteristics of the graph, and the desired number of clusters is guaranteed to be obtained through the post-processing process.

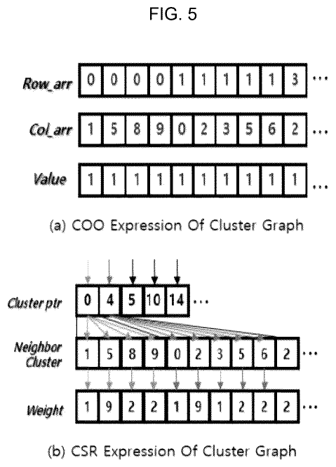

In addition, in the initial partitioning operation (S400), the graph data (cluster graph data) in a COO format generated through the clustering operation (S200) is received and converted into a CSR format as shown in FIG. 5. The CSR expression is advantageous for parallel processing of cluster pointers (Cluster ptr), through which multiple threads of the GPU may effectively access the cluster pointer array. In (b) of FIG. 5, the arrows represent GPU threads. Each thread accesses a neighbor list in CSR format using a thread ID as an index of the cluster pointer. Thereafter, the thread accesses the weight of the adjacent cluster to evaluate the connectivity between the clusters. The weight of the cluster indicates how many corresponding clusters are connected to the vertices of other clusters, and through this, the overall information of the graph data may be indirectly utilized while using the compressed cluster data in the GPU.

In the initial partitioning operation (S400), which partition to optimally assign a specific cluster to is calculated through Equation 2 below.

$$gain ( {P}_{i} , {C}_{j} ) = α \times Vol ( {P}_{i} , {C}_{j} ) + ( 1 - α ) \times D ( {P}_{i} , {C}_{j} ) \qquad [ Equation 2 ]$$

In Equation 2, Vol(Pᵢ, Cⱼ) represents the number of vertices included when cluster Cⱼ is joined to partition Pᵢ. D(Pᵢ, Cⱼ) represents how connected one cluster is to a cluster belonging to another partition.

That is, when cluster Cⱼ is added to partition Pᵢ, a first portion calculates the volume (load balancing) of the partition, and a second portion calculates the degree (connectivity) of the cluster. This is performed for all cluster and partition combinations, and an optimal partition result is produced.

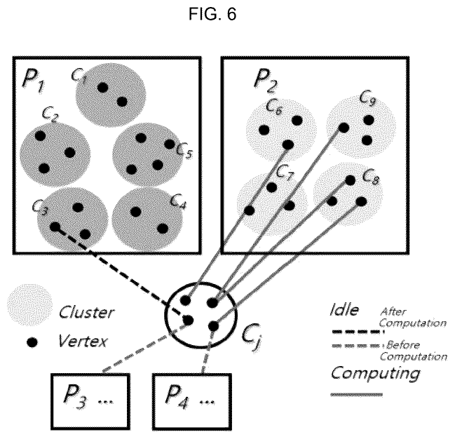

FIG. 6 is an exemplary diagram illustrating the task of determining which partition to assign cluster Cⱼ to at a specific point in time through the initial partitioning operation (S400). As shown in FIG. 6, the entire graph is currently divided into four partitions, and 10 clusters are obtained. The small black circles that are colored are vertices, and the large red and yellow circles including the small circles are clusters. The dotted line indicates that a state of obtaining a gain with the corresponding partition is idle, and the solid line indicates that the current relationship value is being obtained. Here, the dotted line is again divided into black and blue, with the black line indicating that the value has been obtained, and the blue line indicating that the value has not yet been obtained. Clusters {C(1), C(2), C(3), C(4), C(5)} are clusters belonging to partition P(1), and clusters {C(6), C(7), C(8), C(9)} are clusters belonging to partition P(2). In other words, the current cluster Cⱼ has already obtained a gain with C(3) belonging to partition P(1) and is currently in the process of obtaining a gain with the clusters belonging to P(2). At a next point in time, g obtains gains with P(3) and P(4), and as a result, C uses this to determine to which partition to assign Cⱼ.

In the optimization operation (S500), the CPU receives the assigned partition label data, which is the initial partition result, and performs optimization of the assigned partition label data using the generated cluster map array.

That is, in the optimization operation (S500), it is determined, for each vertex, whether quality of a partitioned graph is improved when each vertex is assigned to a different partition of a neighboring vertex, rather than an assigned partition, and optimization of graph partitioning is performed through vertex replication according to a determination result.

In detail, in the optimization operation (S500), vertices are assigned to each partition according to a partition result, and fine adjustment is performed at the vertex level to improve the quality of the partition result. In the partition assignment, each vertex is assigned to an appropriate partition by using the assigned partition label data from the GPU together with the cluster map array in the CPU memory. Fine adjustment is necessary from the perspective of edge distribution and vertex replication between partitions because the GPU performs graph partitioning based on summarized information. Fine adjustment improves the quality of the graph partitioning through load balancing and vertex replication. It is more efficient to perform optimization operation (S500) in the CPU rather than in the GPU in order to minimize the amount of data transfer between the CPU and the GPU.

In the optimization operation (S500), whether the quality of the partitioned graph is improved when each vertex vᵢ and vⱼ assigned to different partitions is assigned to a different partition of a neighboring vertex rather than the existing partition, through Equation 3.

$$\begin{matrix}{C}_{HDRF} ( {v}_{i} , {v}_{j} , p ) = {C}_{rep} ( {v}_{i} , {v}_{j} , p ) + {C}_{bal} ( p ) \\ Score ( {P}_{i} ) = {C}_{HDRF} ( {v}_{i} , {v}_{j} , {p}_{i} ) \\ Score ( {P}_{j} ) = {C}_{HDRF} ( {v}_{i} , {v}_{j} , {p}_{j} )\end{matrix} \qquad [ Equation 3 ]$$

As a result, if Score(Pᵢ) is greater than Score(Pⱼ), vertex v is copied to partition Pᵢ, and if Score(Pᵢ) is less than Score(Pⱼ), vertex v is copied to partition Pⱼ.

In other words, the communication cost between servers in graph partitioning is minimized by applying an HDRF scoring technique that minimizes the number of edge cuts. The partition data up to now has been partitioned based on clusters. The scoring function is activated only when the clusters of adjacent vertices belong to different partitions. To this end, ES data is reused. For example, if vertices vᵢ and vⱼ are assigned to different partitions P(0) and P(2), the scoring function is performed to determine the partition with the highest score. At this time, according to Equation 3 above, if the score of partition P(0) is high, vertex vᵢ is copied, and if the score of P(2) is high, vertex vⱼ is copied.

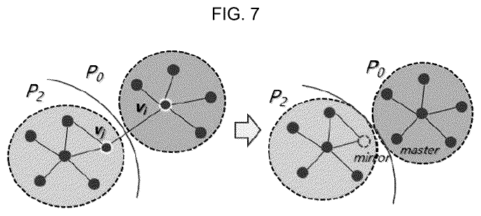

FIG. 7 illustrates the process of vertex replication in the optimization operation (S500). At this time, if vertices vᵢ and vⱼ are assigned to the same partition, the optimization operation (S500) is not performed, and only when vertices vᵢ and vⱼ are assigned to different partitions, the value for performing the optimization operation (S500) is obtained.

In order to prove the superiority of the large graph partitioning method using streaming clustering in a GPU environment according to an exemplary embodiment of the present invention, a comparative performance evaluation was performed with the graph partitioning technique of the related art. In addition, a comparative performance evaluation of the graph partitioning quality was performed with the graph partitioning technique of the related art according to the quality evaluation method.

As the main performance evaluation indicators, execution time, replication factor (RF), load balancing (LB), and locality partitioning (LP) score were considered, and a comparative performance evaluation was performed using data sets of various sizes.

At this time, the execution time is measured as an execution time for performing a specified method on a given graph data set, and the replication factor is a parameter indicating whether a replica of a vertex is maintained for each partition and is defined as in Equation 4 below. The load balancing is defined as in Equation 5 below, and the LP score is an indicator for measuring the locality of the data set and refers to the accuracy of whether the associated clusters are correctly assigned to the divided partitions. In other words, it is determined whether the graph is appropriately divided by utilizing the community as a correct answer for the provided data set.

$$RF = \frac{{\sum }_{i = 1}^{k} ( \vert E ( {P}_{s} ) \vert )}{\vert E ( {P}_{s} ) \vert} \qquad [ Equation 4 ]$$

$$LB = \frac{max ( \vert E ( {P}_{i} ) \vert )}{avg ( \vert E ( {P}_{i} ) \vert )} \qquad [ Equation 5 ]$$

In particular, data locality refers to physical proximity between data and a computing resource that processes the corresponding data in a distributed processing system, which is an important indicator in the field of computer science. The LP score is defined as in Equation 6 below. Here, V(Pᵢ) represents a set of vertices belonging to partition Pᵢ, and V(Cⱼ) represents a set of vertices belonging to the top 5,000 communities Cⱼ with the highest quality. As the LP score is higher, the partition Pᵢ and the community Cⱼ may be considered to be more similar.

$$LP Score = \frac{\vert V ( {P}_{i} ) ⋂ V ( {C}_{j} ) \vert}{\vert V ( {C}_{j} ) \vert} \qquad [ Equation 6 ]$$

According to results of a comparative performance evaluation conducted based thereon, in the case of comparing the execution time according to the graph size, the present invention showed a processing speed about 5 to 15% faster than the partitioning technique of the related art performed in the CPU environment regardless of the graph size. In addition, the GPU-based graph partitioning technique of the related art was not able to be used in a data set with about 200 million or more edges, which means that it is impossible to load graph data including about 200 million or more edges into the GPU memory using the related art technique. In the case of comparing the quality of the graph partitioning, it was found that the present invention showed a difference in the replication factor of up to about 1.9 times that of the related art technique, which is because the present invention uses a clustering-based probabilistic methodology. A graph partitioning technique with a high replication factor has the advantage of improving the possibility of graph data analysis and parallel processing efficiency. In the case of the comparative evaluation of the LP score, it was found that the present invention showed an improvement in the LP score of about 10 to 50% compared to the related art technique. The use of compressed global information plays an important role in achieving locality of graph partitioning, and it means that it is possible to improve the data analysis performance in a distributed graph processing system.

The large graph partitioning method using streaming clustering in a GPU environment according to an exemplary embodiment of the present invention may be applied to various fields, such as social network analysis, medical information systems, recommendation systems, cybersecurity, scientific research and bioinformatics, traffic network analysis, and financial network analysis. For example, relationships between users may be analyzed and communities in social networks, such as Facebook and Twitter, may be detected, and a customized recommendation system for users in an e-commerce platform may be improved. In a medical information system, patient records may be effectively partitioned, disease transmission paths may be tracked, and in the field of cybersecurity, abnormalities may be detected and cyber attack paths may be identified by analyzing network traffic data. In other words, the large graph partitioning method using streaming clustering in a GPU environment according to an exemplary embodiment of the present invention may contribute to efficiently processing and analyzing large graph data in various application fields.

Meanwhile, the large graph partitioning method using streaming clustering in a GPU environment according to an exemplary embodiment of the present invention may be implemented in the form of program commands that may be executed through various electronic units for processing information and recorded on a storage medium. The storage medium may include program commands, data files, data structures, etc. alone or in combination.

According to the present invention, the large graph partitioning method using streaming clustering in a GPU environment has the advantage of overcoming the memory limitations of GPU-based graph partitioning techniques and utilizing a memory access method of a hybrid graph partitioning technique for processing large graph data.

Through this, memory limitations and data transmission overhead may be reduced by compressing transmitted data into key information by utilizing the fast computational ability of the GPU, and large graph data may be efficiently partitioned.

In addition, by clustering similar data and performing partitioning in the GPU, efficient parallel processing tailored to the data size may be supported.

Program commands recorded on a storage medium may be those specifically designed and configured for the present invention or may be known and available to those skilled in the software field. Examples of storage medium include magnetic medium, such as hard disks, floppy disks, and magnetic tape; optical medium, such as CD ROM and DVDs; magneto-optical medium, such as floptical disks; and hardware devices that are specially configured to store and perform program instructions, such as read-only memory (ROM), random access memory (RAM), flash memory, and the like. Examples of program instructions include both machine code, such as those produced by a compiler, and higher level code that may be executed by the computer using an interpreter or the like.

Hereinabove, although the present invention has been described by specific matters, such as detailed components, exemplary embodiments, and the accompanying drawings, they have been provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to these exemplary embodiments, but the claims and all of modifications equal or equivalent to the claims are intended to fall within the scope and spirit of the present invention.

1. A large graph partitioning method using streaming clustering in a GPU environment, the large graph partitioning method comprising:
an input operation of receiving, by a CPU, which is a host, original graph data;
a clustering operation of generating, by the CPU, a cluster map array for the received original graph data using a streaming clustering algorithm and generating cluster graph data using the cluster map array generated for the original graph data;
a transmission operation of receiving, by a GPU, the generated cluster graph data;
an initial partitioning operation of performing, by the GPU, initial partitioning on the received cluster graph data by applying a pre-stored algorithm; and
an optimization operation of receiving, by the CPU, assigned partition label data, which is an initial partitioning result, and performing optimization on the assigned partition label data using the generated cluster map array.

2. The large graph partitioning method of claim 1, wherein, in the clustering operation, the original graph data is assumed to have a form of an edge stream (ES) in which edges are sequentially input, edge information is provided in batch units, and vertices that are closely connected to each vertex are grouped into the same cluster.

3. The large graph partitioning method of claim 2, wherein, in the initial partitioning operation, a label of each node is repeatedly updated according to a label distribution of neighbor nodes by applying a label propagation algorithm, which is a pre-stored algorithm.

4. The large graph partitioning method of claim 3, wherein, in the optimization operation, it is determined, for each vertex, whether the quality of a partitioned graph is improved when each vertex is assigned to a different partition of a neighboring vertex, rather than an assigned partition, and optimization of graph partitioning is performed through vertex replication according to a determination result.

5. A non-transitory computer-readable storage medium storing program commands that, when executed by processing units, cause the processing units to perform the method of claim 1.

6. An apparatus for a large graph partitioning by using streaming clustering in a GPU environment, the apparatus comprising:
a CPU defined as a host, the CPU configured to perform an input operation of receiving original graph data,
the CPU configured to perform a clustering operation of generating a cluster map array for the received original graph data using a streaming clustering algorithm and generating cluster graph data using the cluster map array generated for the original graph data;
a GPU configured to perform a transmission operation of receiving the generated cluster graph data,
the GPU configured to perform an initial partitioning operation of performing initial partitioning on the received cluster graph data by applying a pre-stored algorithm; and
the CPU configured to perform an optimization operation of receiving assigned partition label data, which is an initial partitioning result and performing optimization on the assigned partition label data using the generated cluster map array.

7. The apparatus of claim 6, wherein, in the clustering operation, the original graph data is assumed to have a form of an edge stream (ES) in which edges are sequentially input, edge information is provided in batch units, and vertices that are closely connected to each vertex are grouped into the same cluster.

8. The apparatus of claim 7, wherein, in the initial partitioning operation, a label of each node is repeatedly updated according to a label distribution of neighbor nodes by applying a label propagation algorithm, which is a pre-stored algorithm.

9. The apparatus of claim 8, wherein, in the optimization operation, it is determined, for each vertex, whether the quality of a partitioned graph is improved when each vertex is assigned to a different partition of a neighboring vertex, rather than an assigned partition and optimization of graph partitioning is performed through vertex replication according to a determination result.
